(19) United States
(12) Patent Application Publication
(10) Pub. No.: US 2024/0144071 A1
(43) Pub. Date: May 2, 2024

(54) QUANTUM SERVICE AUTOSCALING

(71) Applicant: Red Hat, Inc., Raleigh, NC (US)

(72) Inventors: Leigh Griffin, Waterford (IE); Stephen Coady, Waterford (IE)

(21) Appl. No.: 17/973,880

(22) Filed: Oct. 26, 2022

(51) Int. Cl. G06N 10/80; G06N 10/20

(52) U.S. Cl. CPC G06N 10/80; G06N 10/20

(57) ABSTRACT

A first quantum computing device receives a first set of computational information that reflects a utilization of computing resources of a first quantum service in a first quantum computing system that exceeds a computing resources threshold. The computing resources of the first quantum service in the first quantum computing system are altered based on the first set of computational information. The first quantum computing device then determines that the utilization of computing resources of the first quantum service in the first quantum computing system continues to exceed the computing resources threshold. The first quantum computing device causes an initiation of a copy of the first quantum service onto a second quantum computing device in a second quantum computing system.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. As quantum computing continues to increase in popularity and become more commonplace, an ability to efficiently and accurately allocate qubits in real time will be desirable.

### SUMMARY

The examples disclosed herein implement a quantum service autoscaler that performs automatic scaling of quantum services. In particular, the quantum service autoscaler provisions computing resources to the quantum service for the quantum service to perform the tasks of the quantum service. The quantum service autoscaler can allow quantum services to increase their capacity and handle more load by providing the quantum services with the computing resources to do so when under heavy load or increased throughput. When the computing resources of a first quantum computing system are insufficient to allow the quantum service to perform tasks, the quantum service autoscaler begins an autoscale migration of the quantum service to a second quantum computing system, resulting in the quantum service running in the second computing system with the increased resources required to perform tasks.

In one example, a method for automatic scaling of quantum services is disclosed. The method includes receiving, by a first quantum computing device, a first set of computational information reflecting a utilization of computing resources of a first quantum service in a first quantum computing system that exceeds a computing resources threshold. The method further includes altering, by the first quantum computing device, the computing resources of the first quantum service in the first quantum computing system based on the first set of computational information.

In another example, a quantum computing device for automatic scaling of quantum services is disclosed. The quantum computing device comprises a memory, and a processor device communicatively coupled to the memory. The processor device is to receive a first set of computational information reflecting a utilization of computing resources of a first quantum service in a first quantum computing system that exceeds a computing resources threshold. The processor device is further to alter the computing resources of the first quantum service in the first quantum computing system based on the first set of computational information. The processor device is further to, subsequent to alter the computing resources of the first quantum service in the first quantum computing system, determine that the utilization of computing resources of the first quantum service in the first quantum computing system continues to exceed the computing resources threshold. The processor device is further to cause an initiation of a copy of the first quantum service onto a second quantum computing device in a second quantum computing system.

In another example, a non-transitory computer-readable storage medium is disclosed. The non-transitory computer-readable storage medium stores thereon computer-executable instructions that, when executed, cause one or more processor devices to receive a first set of computational information reflecting a utilization of computing resources of a first quantum service in a first quantum computing system that exceeds a computing resources threshold. The instructions further cause the processor device to alter the computing resources of the first quantum service in the first quantum computing system based on the first set of computational information. The instructions further cause the processor device to, subsequent to alter the computing resources of the first quantum service in the first quantum computing system, determine that the utilization of computing resources of the first quantum service in the first quantum computing system continues to exceed the computing resources threshold. The instructions further cause the processor device to cause an initiation of a copy of the first quantum service onto a second quantum computing device in a second quantum computing system.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum computing system in which examples of automatic scaling of quantum services may be practiced;

FIG. 2 is a flowchart illustrating operations performed by the quantum computing system of FIG. 1 for automatic scaling of quantum services, according to one example;

FIG. 3 is a simpler block diagram of the quantum computing system of FIG. 1 for automatic scaling of quantum services, according to one example;

FIG. 4 is a simpler block diagram of the first quantum computing device of FIG. 1 for automatic scaling of quantum services, according to one example;

FIG. 5 is a simpler block diagram of the first quantum computing device of FIG. 1 for automatic scaling of quantum services, according to one example;

FIG. 6 is a simpler block diagram of the quantum computing system of FIG. 1 for automatic scaling of quantum services, according to one example;

FIG. 7 is a simpler block diagram of the quantum computing system of FIG. 1 for automatic scaling of quantum services, according to one example; and

FIG. 8 is a block diagram of a quantum computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first executing quantum service” and “second executing quantum service,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

Quantum services executed by a quantum computing device need to be provisioned with the correct computing resources in order to perform tasks. However, when there is a heavy load or increased throughput in the quantum computing device, the computing resources can be placed under pressure, causing the quantum service to fail to perform tasks as expected.

The examples disclosed herein implement a quantum service autoscaler service that performs automatic scaling of quantum services. The quantum service autoscaler can allow quantum services to handle more load by providing additional computing resources to the quantum service in a first quantum computing system. When the quantum service reaches a limit of the computing resources, the quantum service autoscaler can begin an autoscale migration of the quantum service to a quantum computing device in a second quantum computing system.

A quantum service running on a quantum device in a first quantum computing system may be provisioned with and utilize computing resources in the first quantum computing system in order to perform a task. Over time, the quantum service may require additional computing resources in order to perform the task. For example, one or more of the Quantum Processing Unit (QPU) load, the bandwidth within a quantum computing system, the number of qubits available for the quantum service, tension in the quantum computing system, heat in the quantum computing system, decoherence, and error count may increase the stress on the computing resources utilized by the quantum service in the quantum computing system. As a result, a computing resources limit or threshold of the quantum service or the first quantum computing system may be reached or exceeded by the quantum service; thus the quantum service will require additional computing resources in order to perform the task. In response to the increased load and throughput, the quantum service autoscaler can increase the computing resources provisioned for and utilized by the quantum service in first quantum computing system. For example, the quantum service autoscaler may provide the quantum service with access to additional qubits by requesting an available qubit from a qubit registry, increase the priority of the quantum service with respect to other quantum services in the first quantum computing system, alter a strategy for error correction for the quantum service, increase a number of qubits that are available for error correction, parallelize the execution of the quantum service in the first quantum computing system, terminate non-essential quantum services in the first quantum computing system, or terminate quantum services in the first quantum computing system in order to reduce a heat profile in the first quantum computing system.

The quantum service autoscaler can provide the increased computing resources to the quantum service, however, the computing resources utilized by the quantum service in the first quantum computing system may continue to reach or exceed the computing resources limit or threshold. As a result, the quantum service autoscaler can cause a copy of the quantum service to be initiated on a quantum computing device in a second quantum computing system. For example, the quantum service autoscaler may receive information that the utilization of computing resources in the second quantum computing system does not reach a computing resources limit or threshold of the second quantum computing system. The quantum service autoscaler can send a Quantum Assembly (QASM) file that corresponds to the first quantum service to the second quantum computing system, where the copy of the quantum service will be initiated with the computing resources of the second quantum computing system.

As the copy of the quantum service is initiated with the computing resources of the second quantum computing system, the quantum service autoscaler can load balance the old instantiation of the quantum service on the first quantum computing system and the new instantiation of the quantum service on the second quantum computing system. The quantum service autoscaler can determine that there are enough computing resources for the quantum service to run on a quantum computing device in the second quantum computing system. In response, the quantum service autoscaler can scale down the quantum service in the first quantum computing system, redirect traffic to the new instantiation of the quantum service in the second quantum computing system, and terminate the execution of the quantum service in the first quantum computing system.

The quantum service autoscaler may identify the utilization of computer resources of the quantum service at multiple times of the day. For example, the quantum service autoscaler may determine that it is a first time of day and the computing resources that are required for the quantum service to perform a task at the first time of day. At the first time of day, the quantum service autoscaler can initiate a copy of the quantum service onto a quantum computing device in the second quantum computing system with the computing resources necessary for the quantum service to perform the task.

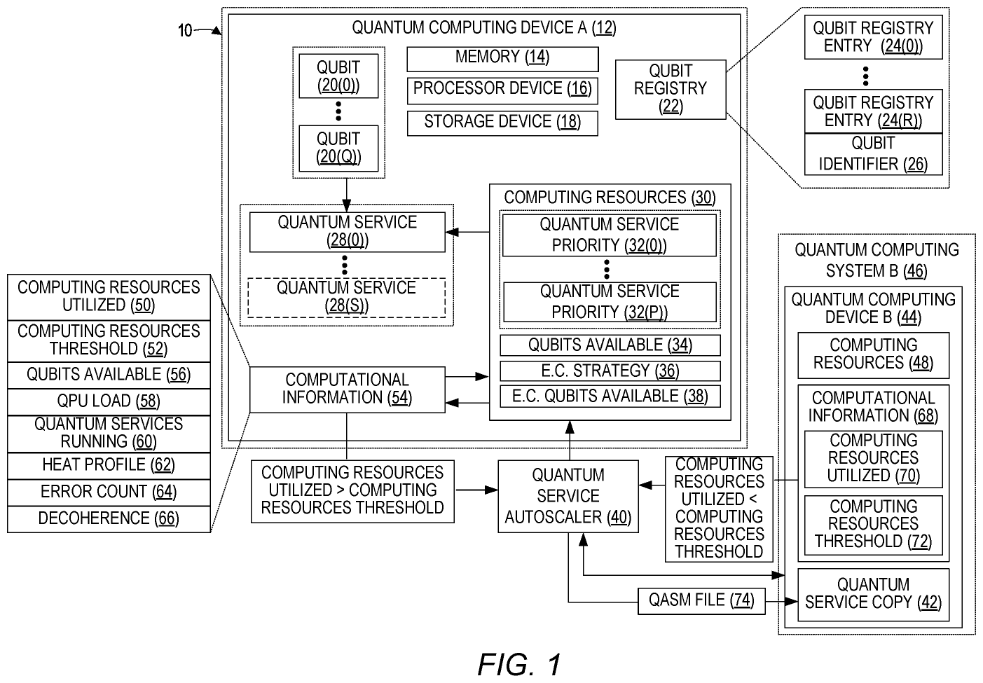

FIG. 1 is a block diagram of a first quantum computing system 10 that comprises a first quantum computing device 12, a memory 14, a processor device 16, and a storage device 18. It is to be understood that the first quantum computing device 12 in some examples may include constituent elements in addition to those illustrated in FIG. 1.

In the example of FIG. 1, the first quantum computing device 12 implements a set of one or more qubits 20(0)-20(Q) for use by quantum services executed by the first quantum computing device 12. To maintain information for the qubits 20(0)-20(Q), the first quantum computing device 12 includes a qubit registry 22, which comprises a plurality of qubit registry entries 24(0)-24(R) each corresponding to a qubit such as the one or more qubits 20(0)-20(Q). The qubit registry 22 maintains and provides access to data relating to the qubits implemented by the first quantum computing device 12, such as a count of the total number of qubits implemented by the first quantum computing device 12 and a count of the number of available qubits that are currently available for allocation, as non-limiting examples. Each of the qubit registry entries 24(0)-24(R) of the qubit registry 22 also stores qubit metadata (not shown) for a corresponding qubit. The qubit metadata may include, as non-limiting examples, a qubit identifier 26, an availability indicator that indicates whether the corresponding qubit is available for use or is in use by a specific quantum service, an identifier of a quantum service that is associated with the corresponding qubit or to which the corresponding qubit is allocated, and/or a quantum phenomena indicator that indicates whether the corresponding qubit is in an entangled state and/or a superposition state.

The first quantum computing device 12 of FIG. 1 executes one or more quantum services 28(0)-28(S). The quantum services 28(0)-28(S) are processes that employ qubits such as the one or more qubits 20(0)-20(Q) to provide desired functionality. The quantum services 28(0)-28(S) may utilize computing resources 30 that include quantum services priorities 32(0)-32(P), a quantity of qubits available 34, an error correction strategy 36, and a quantity of qubits available for error correction 38.

The first quantum computing device 12 of FIG. 1 implements a quantum service autoscaler 40 that performs automatic scaling of quantum services. The quantum service autoscaler 40 can provision computing resources for the one or more quantum services 28(0)-28(S) running on the first quantum computing device 12 in the first quantum computing system 10. When an amount of computing resources utilized 50 by one or more quantum services 28(0)-28(S) in the first quantum computing system 10 exceeds a computing resources threshold 52, the quantum service autoscaler 40 can initiate a copy 42 of the one or more quantum services 28(0)-28(S) running on the first quantum computing device 12 in the first quantum computing system 10 onto a second quantum computing device 44 in a second quantum computing system 46. The copy 42 can be provisioned with the computing resources 48 of the second quantum computing device 44.

Specifically, the quantum service autoscaler 40 can receive a first set of computational information 54. The computational information 54 may include one or more of the amount of computing resources utilized 50 by the one or more quantum services 28(0)-28(S) in the first quantum computing system 10, the computing resources threshold 52, a quantity of qubits available 56, a QPU load 58, a quantity of quantum services running 60 in the first quantum computing system 10, a heat profile 62 of the first quantum computing system 10, an error count 64 of the first quantum computing system 10, and an amount of decoherence 66 in the first quantum computing system 10. The computational information 54 may reflect that the computing resources utilized 50 by a first quantum service 28(0) in the first quantum computing system 10 exceeds the computing resources threshold 52. The computing resources threshold 52 may apply to a limit of computing resources in the one or more quantum services 28(0)-28(S), such as the first quantum service 28(0), or in the first quantum computing system 10.

The quantum service autoscaler 40 may interface with a task manager to alter the computing resources 30 of the first quantum service 28(0) in the first quantum computing system 10 based on the computational information 54 in order to provide additional computing resources 30 for the first quantum service 28(0).

For example, the quantum service autoscaler 40 may prioritize the first quantum service 28(0) over the other quantum services 28(0)-28(S) executing in the first quantum computing system 10. In another example, the quantum service autoscaler 40 may increase the number of qubits available 34 to the first quantum service 28 in order to allocate more qubits 20(0)-20(Q) to the first quantum service 28(0), such as by contacting the qubit registry 22. The quantum service autoscaler 40 may alter the error correction strategy 36 for the first quantum service 28(0) or increase the quantity of qubits available for error correction 38 by contacting the qubit registry 22 for an available qubit and allocating the available qubit for error correction for the first quantum service 28(0). In another example, the quantum service autoscaler 40 may determine that a second quantum service 28(S) in the first quantum computing system 10 is not an essential service for the first quantum computing device 12 or the first quantum computing system 10, and terminate the second quantum service 28(S). The quantum service autoscaler 40 may determine that the heat profile 62 of the first quantum computing system 10 may be reduced by terminating one or more of the quantum services 28(0)-28(S) in the first quantum computing system 10.

Altering the computing resources 30 of the first quantum service 28(0) in the first quantum computing system 10 may be insufficient for the first quantum service 28(0) to perform tasks in the first quantum computing system 10. There may continue to be resource constraints in the first quantum computing system which may not be corrected to allow the first quantum service 28(0) to run in the first quantum computing system 10. After altering the computing resources of the first quantum service 28(0) in the first quantum computing system 10 based on the computational information 54, the quantum service autoscaler 40 may determine that the computing resources utilized 50 by the first quantum service 28(0) in the first quantum computing system 10 continues to exceed the computing resources threshold 52. The quantum service autoscaler 40 can look to other quantum systems within its network and communicate with the other quantum systems to determine whether another quantum system has computing resources available for the first quantum service 28(0) to perform tasks in the other quantum system.

For example, the quantum service autoscaler 40 may verify one or more of an amount of computing resources utilized 70, a computing resources threshold 72, a quantity of qubits available, a QPU load, a quantity of quantum services running, a heat profile, an error count, and an amount of decoherence 66 in the second quantum computing system 46. The computational information 54 may reflect that the computing resources utilized 50 by the first quantum service 28(0) in the first quantum computing system 10 exceeds the computing resources threshold 52. The quantum service autoscaler 40 may initiate a copy 42 of the first quantum service 28(0) onto the second quantum computing device 44 in the second quantum computing system 46. The first quantum service 28(0) may then run with the computing resources 48 in the second quantum computing system 46 that are necessary for the first quantum service 28(0) to perform tasks.

In one example, the quantum service autoscaler 40 may receive a second set of computational information 68 from the second quantum computing device 44. The second set of computational information 68 may reflect the amount of computing resources utilized 70 of the second quantum computing system 46. The amount of computing resources utilized 70 may fall below the computing resources threshold 72 for the second quantum computing system 46. The quantum service autoscaler 40 may cause the initiation of a copy 42 of the first quantum service 28(0) onto the second quantum computing device 44 in the second quantum computing system 46 based on the second set of computational information 68 reflecting that the amount of computing resources utilized 70 is below the computing resources threshold 72.

In another example, the quantum service autoscaler 40 may send a QASM file 74 that corresponds to the first quantum service 28(0) from the first quantum computing device 12 to the second quantum computing system 46. The quantum service autoscaler 40 may request the second quantum computing system 46 to initiate a copy 42 of the first quantum service 28(0) onto the second quantum computing device 44. The copy 42 of the first quantum service 28(0) on the second quantum computing device 44 may be provisioned with the computing resources 48 of the second quantum computing device 44. The QASM file 74 may be sent to the task manager of the second quantum computing device 44 in order to execute the first quantum service 28(0).

The quantum service autoscaler 40 may receive a request that is directed to the first quantum service 28(0). The quantum service autoscaler 40 may send the request from the first quantum computing device 12 to the copy 42 of the first quantum service 28(0) on the second quantum computing device 44. For example, the quantum service autoscaler 40 may communicate with a scheduler and task manager to load balance the first quantum service 28(0) on the first quantum computing device 12 and the copy 42 of the first quantum service 28(0) on the second quantum computing device 44. Requests may be sent between the first quantum service 28(0) and the copy 42 of the first quantum service 28(0) until the first quantum service 28(0) can be satisfactorily terminated on the first quantum computing device 12. The first quantum service 28(0) may be satisfactorily terminated, for example, after a specified number of requests, a specified period of time, or based on the computing resources threshold 52 or 72. In another example, every second request from the first quantum service 28(0) may be sent to the copy 42 of the first quantum service 28(0). The requests to one instantiation of the first quantum service 28(0) may be paused in favor of the other instantiation of the first quantum service 28(0). For example, the copy 42 of the first quantum service 28(0) may be favored until one or more computing resources 30 of the first quantum service 28(0) in the first quantum computing system 10 are available that can allow the first quantum service 28(0) to continue to run in the first quantum computing system 10. For instance, the copy 42 of the first quantum service 28(0) may be favored until the heat profile 62 of the first quantum computing system 10 is reduced to a satisfactory level to allow the first quantum service 28(0) to continue to run in the first quantum computing system 10.

It is to be understood that, because the quantum service autoscaler 40 is a component of the first quantum computing device 12, functionality implemented by the quantum service autoscaler 40 may be attributed to the first quantum computing device 12 generally. Moreover, in examples where the quantum service autoscaler 40 comprises software instructions that program the processor device 16 to carry out functionality discussed herein, functionality implemented by the quantum service autoscaler 40 may be attributed herein to the processor device 16. It is to be further understood that while, for purposes of illustration only, the quantum service autoscaler 40 is depicted as a single component, the functionality implemented by the quantum service autoscaler 40 may be implemented in any number of components, and the examples discussed herein are not limited to any particular number of components.

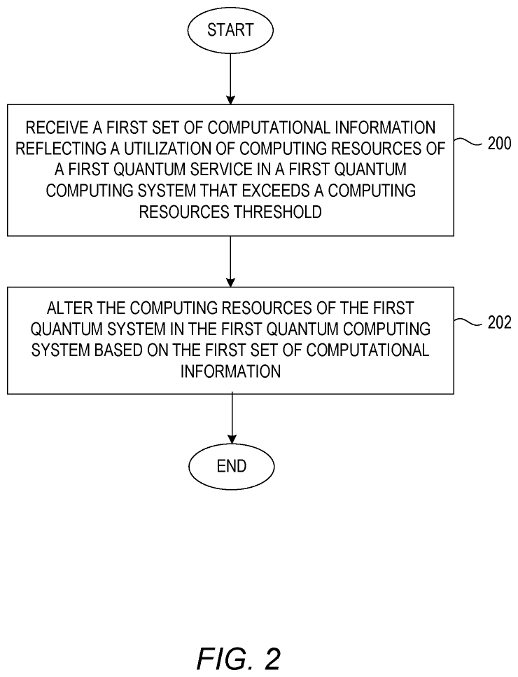

To illustrate exemplary operations performed by the first quantum computing system 10 of FIG. 1 for automatic scaling of quantum services according to one example, FIG. 2 provides a flowchart. Elements of FIG. 1 are referenced in describing FIG. 2 for the sake of clarity.

In FIG. 2, operations begin with a processor device of a quantum computing device, such as the processor device 16 of the first quantum computing device 12 of FIG. 1, receiving a first set of computational information 54 reflecting a utilization of computing resources 50 of a first quantum service 28(0) in a first quantum computing system 10 that exceeds a computing resources threshold 52 (block 200).

The processor device 16 then alters the computing resources 30 of the first quantum service 28(0) in the first quantum computing system 10 based on the first set of computational information 54 (block 202).

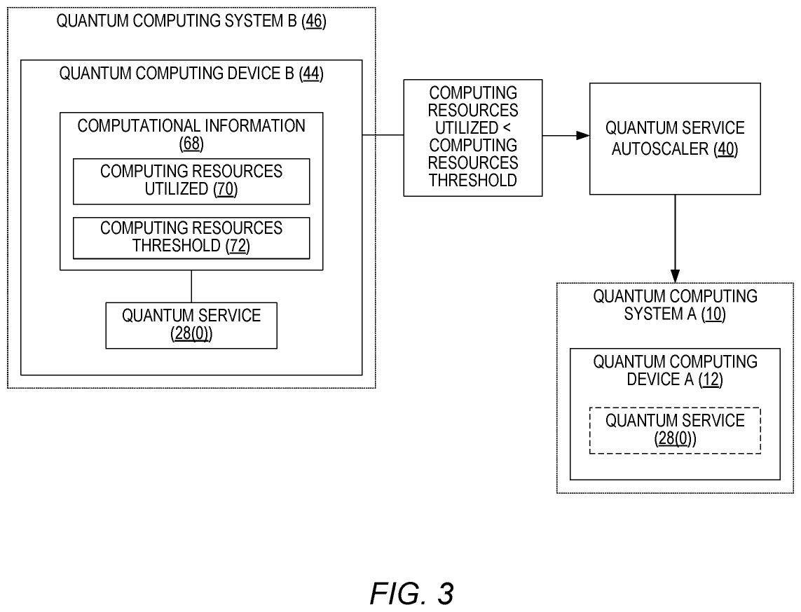

FIG. 3 is a simpler block diagram of the first quantum computing system 10 of FIG. 1 for automatic scaling of quantum services, according to one example. Elements of FIG. 1 are referenced in describing FIG. 3 for the sake of clarity. In the example of FIG. 3, the first quantum service 28(0) may be running in the second quantum computing device 44 in the second quantum computing system 46 and the first quantum computing device 12 in the first quantum computing system 10. For example, the first quantum service 28(0) on the second quantum computing device 44 may be a copy instantiated by the quantum service autoscaler 40. The second quantum computing device 44 may contain computational information 68 that reflects the amount of computing resources utilized 70 and the computing resources threshold 72 of the second quantum computing system 46. The quantum service autoscaler 40 may determine that the computer resources utilized 70 by the first quantum service 28(0) does not exceed the computing resources threshold 72 for the second quantum computing system 46. In response, the quantum service autoscaler 40 may terminate the execution of the first quantum service 28(0) on the first quantum computing device 12 in the first quantum computing system 10 and continue executing the first quantum service 28(0) on the second quantum computing device 44 in the second quantum computing system 46.

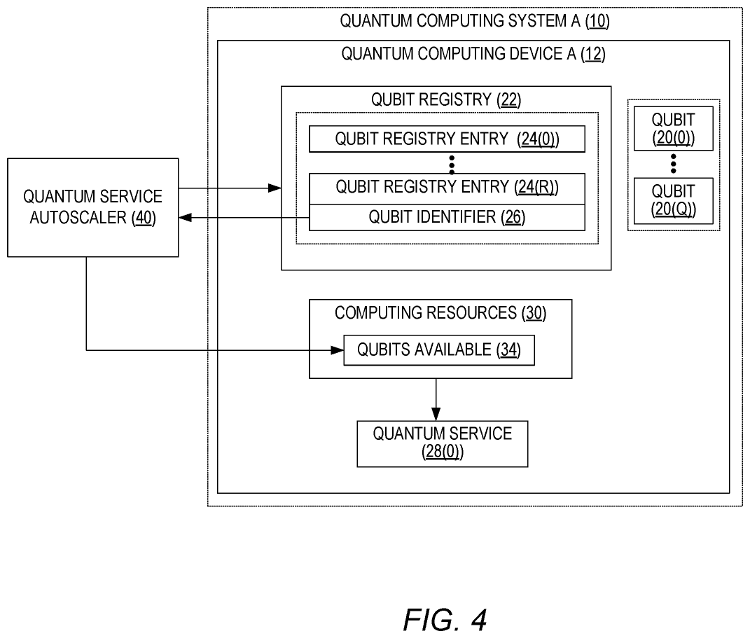

FIG. 4 is a simpler block diagram of the first quantum computing device 12 of FIG. 1 for automatic scaling of quantum services, according to one example. Elements of FIG. 1 are referenced in describing FIG. 4 for the sake of clarity. In the example of FIG. 4, the quantum service autoscaler 40 may alter the computing resources 30 for the first quantum service 28(0) on the first quantum computing device 12 in the first quantum computing system 10 by increasing the number of qubits available 34 for the first quantum service 28(0). The quantum service autoscaler 40 may request an available qubit from the qubit registry 22. The qubit registry entries 24(0)-24(R), each corresponding to a qubit a qubit such as the one or more qubits 20(0)-20(Q) in the first quantum computing device 12, may indicate one or more qubits 20(0)-20(Q) that are available for the first quantum service 28(0). The qubit registry 22 may send the qubit identifier 26 corresponding to the qubit registry entry 24(0)-24(R) that identifies an available qubit to the quantum service autoscaler 40. The quantum service autoscaler 40 may then send a communication to the first quantum service 28(0) indicating the qubit that is available. For instance, the computing resources 30 may indicate the qubit available 34 for the first quantum service 28(0) to use.

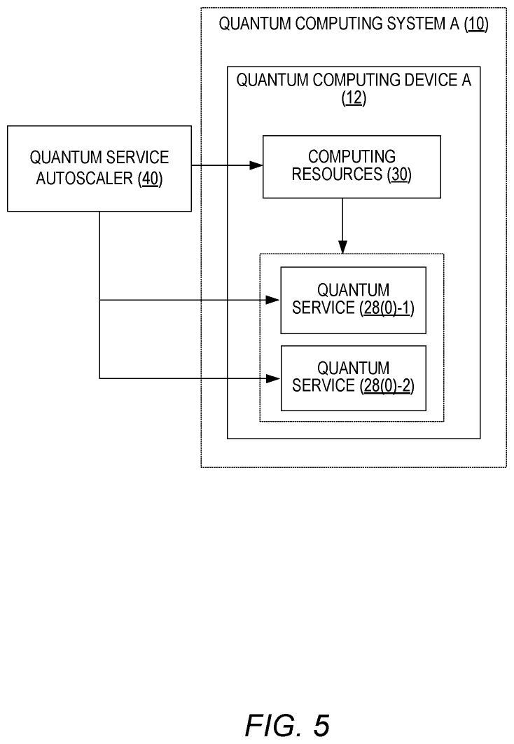

FIG. 5 is a simpler block diagram of the first quantum computing device 12 of FIG. 1 for automatic scaling of quantum services, according to one example. Elements of FIG. 1 are referenced in describing FIG. 5 for the sake of clarity. In the example of FIG. 5, the quantum service autoscaler 40 may alter the computing resources 30 of the first quantum service 28(0)-1 on the first quantum computing device 12 in the first quantum computing system 10 by parallelizing the execution of the first quantum service 28(0)-1. For example, the quantum service autoscaler 40 may simultaneously execute both the first quantum service 28(0)-1 and the first quantum service 28(0)-2 on the first quantum computing device 12 in the first quantum computing system 10. As a result, the load on the first quantum computing device 12 may be reduced for the first quantum service 28(0) to successfully perform tasks.

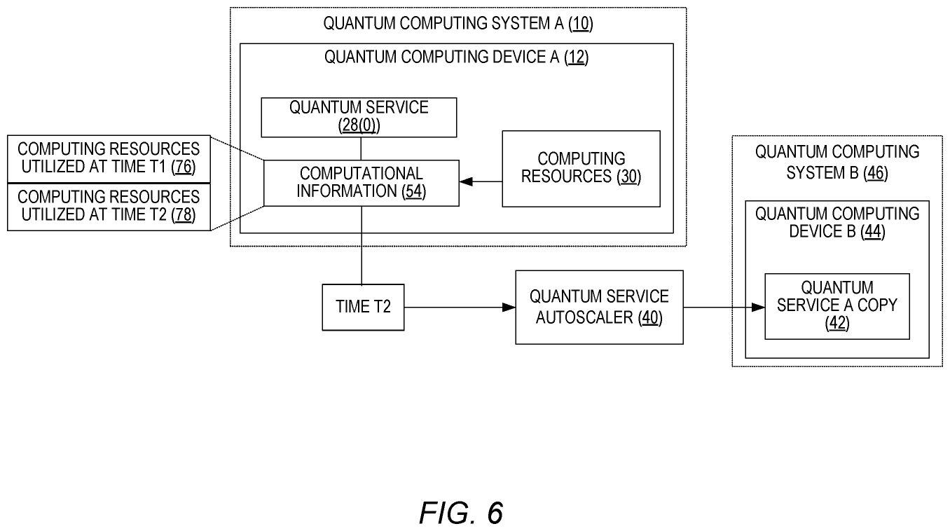

FIG. 6 is a simpler block diagram of the first quantum computing system 10 of FIG. 1 for automatic scaling of quantum services, according to one example. Elements of FIG. 1 are referenced in describing FIG. 6 for the sake of clarity. In the example of FIG. 6, the quantum service autoscaler 40 may identify a utilization of computing resources at multiple times of day and initiate automatic scaling of quantum services at one or more of the times of day. The quantum service autoscaler 40 may identify computing resources utilized at time T1 76 and computing resources utilized at time T2 78 of the first quantum service 28(0) on the first quantum computing device 12 in the first quantum computing system 10. Information indicating the computing resources utilized at time T1 76 and the computing resources utilized at time T2 78 may be reflected in the computational information 54. The quantum service autoscaler 40 may determine that it is the second time of day. The quantum service autoscaler 40 may then initiate a copy 42 of the first quantum service 28(0) onto the second quantum computing device 44 in the second quantum computing system 46. For example, the quantum service autoscaler 40 may detect a spike in traffic in the first quantum computing system 10 every day from 9:00 a.m. until 10:00 a.m. As a result, the quantum service autoscaler 40 may pre-schedule automatic scaling of quantum services from 9:00 a.m. until 10:00 a.m. every day. The quantum service autoscaler 40 may have an instantiation of the first quantum service 28(0) ready every day at 9:00 a.m. to initiate in the second quantum computing system 46 in order to handle the increased load on the first quantum computing system 10. The quantum service autoscaler 40 can load balance and proxy requests between the first quantum service 28(0) and the instantiation of the first quantum service 28(0), initiate the instantiation of the first quantum service 28(0) on the second quantum computing device 44, and terminate the instantiation of the first quantum service 28(0) on the second quantum computing device 44 at a time when traffic in the first quantum computing system 10 decreases. For example, the quantum service autoscaler 40 may detect a decrease in traffic in the first quantum computing system 10 every day at 11:00 a.m. and terminate the instantiation of the first quantum service 28(0) on the second quantum computing device 44 at 11:00 a.m. every day.

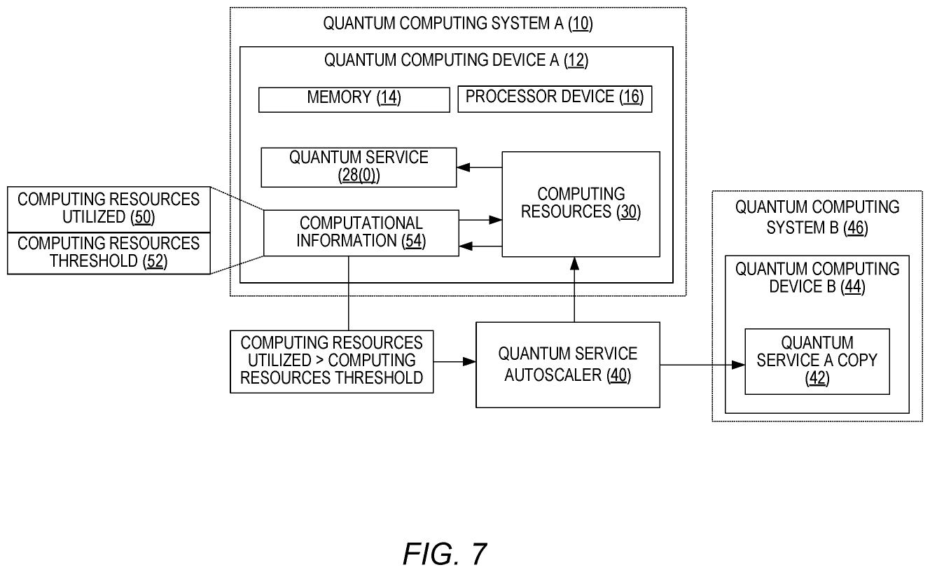

FIG. 7 is a simpler block diagram of the first quantum computing system 10 of FIG. 1 for automatic scaling of quantum services, according to one example. Elements of FIG. 1 are referenced in describing FIG. 7 for the sake of clarity. FIG. 7 includes the first quantum computing system 10, which in turn includes the first quantum computing device 12. The first quantum computing device 12 includes the memory 14 and the processor device 16 coupled to the memory 14. The processor device 16 is to receive the first set of computational information 54 reflecting the utilization of computing resources 50 of the first quantum service 28(0) in the first quantum computing system 10 that exceeds the computing resources threshold 52. The processor device 16 is further to alter the computing resources 30 of the first quantum service 28(0) in the first quantum computing system 10 based on the first set of computational information 54. The processor device 16 is further to determine that the utilization of computing resources 50 of the first quantum service 28(0) in the first quantum computing system 10 continues to exceed the computing resources threshold 52. The processor device 16 is further to cause the initiation of a copy 42 of the first quantum service 28(0) onto the second quantum computing device 44 in the second quantum computing system 46.

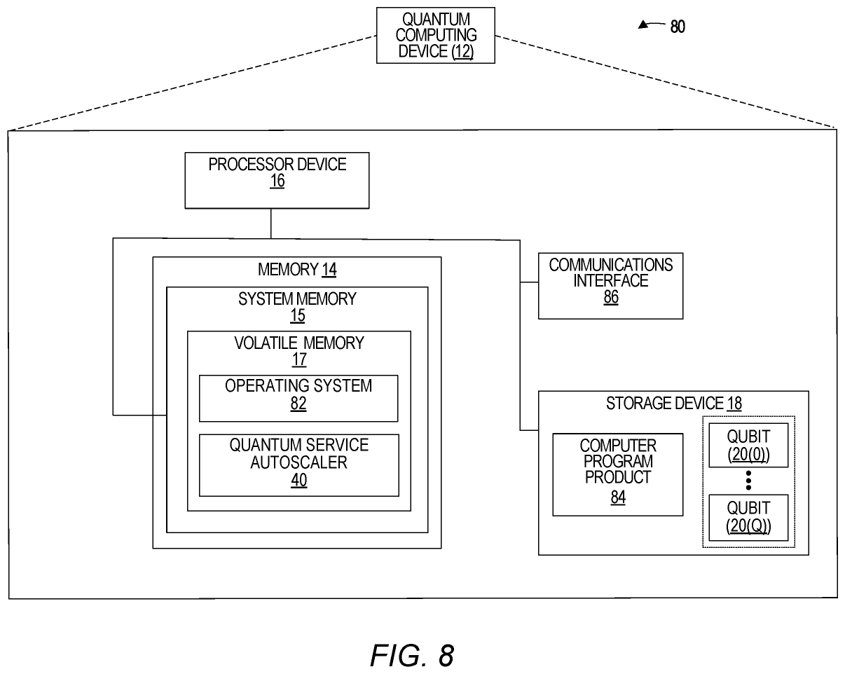

FIG. 8 is a block diagram of a quantum computing device 80, such as the first quantum computing device 12 of FIG. 1, suitable for implementing examples according to one example. Elements of FIG. 1 are referenced in describing FIG. 8 for the sake of clarity. The quantum computing device 80 may comprise any suitable quantum computing device or devices. The quantum computing device 80 can operate using classical computing principles or quantum computing principles. Thus, in some implementations, portions of the quantum computing device 80 (e.g., the quantum service autoscaler 40) may be executed using classical computing components and/or algorithms. When using quantum computing principles, the quantum computing device 80 performs computations that utilize quantum-mechanical phenomena, such as superposition and entanglement. The quantum computing device 80 may operate under certain environmental conditions, such as at or near zero degrees (0°) Kelvin. When using classical computing principles, the quantum computing device 80 utilizes binary digits that have a value of either zero (0) or one (1).

The quantum computing device 80 includes a processor device 16 and a memory 14. The processor device 16 can be any commercially available or proprietary processor suitable for operating in a quantum environment. The memory 14 may include system memory 15 and volatile memory 17 (e.g., random-access memory (RAM)).

The quantum computing device 80 may further include or be coupled to a non-transitory computer-readable storage medium such as a storage device 18. The storage device 18 may comprise, for example, an internal or external hard disk drive (HDD) (e.g., enhanced integrated drive electronics (EIDE) or serial advanced technology attachment (SATA)) for storage, memory, or the like. The storage device 18 and other drives associated with computer-readable media and computer-usable media may provide non-volatile storage of data, data structures, computer-executable instructions, and the like. The storage device may also provide functionality for storing one or more qubits 20(0)-20(Q).

A number of modules can be stored in the storage device 18 and in the volatile memory 15, including an operating system 82 and one or more modules, such as the quantum service autoscaler 40. All or a portion of the examples may be implemented as a computer program product 84 stored on a transitory or non-transitory computer-usable or computer-readable storage medium, such as the storage device 18, which includes complex programming instructions, such as complex computer-readable program code, to cause the processor device 16 to carry out the steps described herein. Thus, the computer-readable program code can comprise computer-executable instructions for implementing the functionality of the examples described herein when executed on the processor device 16.

An operator may also be able to enter one or more configuration commands through a keyboard (not illustrated), a pointing device such as a mouse (not illustrated), or a touch-sensitive surface such as a display device (not illustrated). The quantum computing device 80 may also include a communications interface 86 suitable for communicating with other quantum computing systems, including, in some implementations, classical computing devices.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a first quantum computing device, a first set of computational information reflecting a utilization of computing resources of a first quantum service in a first quantum computing system that exceeds a computing resources threshold; and
altering, by the first quantum computing device, the computing resources of the first quantum service in the first quantum computing system based on the first set of computational information.

2. The method of claim 1, further comprising:
subsequent to altering the computing resources of the first quantum service in the first quantum computing system, determining, by the first quantum computing device, that the utilization of computing resources of the first quantum service in the first quantum computing system continues to exceed the computing resources threshold; and
causing, by the first quantum computing device, an initiation of a copy of the first quantum service onto a second quantum computing device in a second quantum computing system.

3. The method of claim 2, wherein causing the initiation of the copy of the first quantum service onto the second quantum computing device in the second quantum computing system comprises receiving, by the first quantum computing device, a second set of computational information reflecting a utilization of computing resources of the second quantum computing system that falls below a computing resources threshold for the second quantum computing system.

4. The method of claim 2, wherein causing the initiation of the copy of the first quantum service onto the second quantum computing device in the second quantum computing system comprises:
sending, by the first quantum computing device to the second quantum computing system, a Quantum Assembly (QASM) file corresponding to the first quantum service; and
requesting, by the first quantum computing system, the second quantum computing system to initiate the copy of the first quantum service onto the second quantum computing device.

5. The method of claim 2, further comprising:
receiving, by the first quantum computing device, a request directed toward the first quantum service; and
sending, by the first quantum computing device, the request to the copy of the first quantum service on the second quantum computing device.

6. The method of claim 1, wherein the computing resources threshold applies to the first quantum service.

7. The method of claim 6, further comprising:
determining that a utilization of computing resources of the first quantum service in a second quantum computing system does not exceed a computing resources threshold for the second quantum computing system; and
in response, terminating execution of the first quantum service on the first quantum computing system.

8. The method of claim 1, wherein the computing resources threshold applies to the first quantum computing system.

9. The method of claim 1, wherein the first set of computational information comprises one or more of a number of qubits available, a QPU load, a number of quantum services running, a heat profile, an error count, and a decoherence in the first quantum computing system.

10. The method of claim 1, wherein altering the computing resources of the first quantum service in the first quantum computing system comprises increasing a priority of the first quantum service with respect to a priority of a plurality of quantum services executing in the first quantum computing system.

11. The method of claim 1, wherein altering the computing resources of the first quantum service in the first quantum computing system comprises increasing a number of qubits available for the first quantum service.

12. The method of claim 11, wherein increasing the number of qubits available for the first quantum service comprises:
requesting, from a qubit registry, an available qubit;
receiving, from the qubit registry, a qubit identifier identifying an available qubit; and
communicating, to the first quantum service, information that identifies the available qubit.

13. The method of claim 1, wherein altering the computing resources of the first quantum service in the first quantum computing system comprises altering a strategy for error correction for the first quantum service.

14. The method of claim 1, wherein altering the computing resources of the first quantum service in the first quantum computing system comprises increasing a number of qubits available for error correction.

15. The method of claim 1, wherein altering the computing resources of the first quantum service in the first quantum computing system comprises parallelizing execution of the first quantum service in the first quantum computing system.

16. The method of claim 1, wherein altering the computing resources of the first quantum service in the first quantum computing system comprises:
determining that a second quantum service in the first quantum computing system is not an essential service; and
terminating the second quantum service.

17. The method of claim 1, wherein altering the computing resources of the first quantum service in the first quantum computing system comprises terminating other quantum services in the first quantum computing system to reduce a heat profile of the first quantum computing system.

18. The method of claim 1, further comprising:
identifying a utilization of computing resources of the first quantum service in the first quantum computing system at a first time of day and a utilization of computing resources of the first quantum service in the first quantum computing system at a second time of day;
determining that it is the second time of day; and
causing, by the first quantum computing device, an initiation of a copy of the first quantum service onto a second quantum computing device in a second quantum computing system.

19. A quantum computing device, comprising:
a memory; and
a processor device coupled to the memory, the processor device to:
receive a first set of computational information reflecting a utilization of computing resources of a first quantum service in a first quantum computing system that exceeds a computing resources threshold;
alter the computing resources of the first quantum service in the first quantum computing system based on the first set of computational information;
subsequent to alter the computing resources of the first quantum service in the first quantum computing system, determine that the utilization of computing resources of the first quantum service in the first quantum computing system continues to exceed the computing resources threshold; and
cause an initiation of a copy of the first quantum service onto a second quantum computing device in a second quantum computing system.

20. A non-transitory computer-readable storage medium that includes computer-executable instructions that, when executed, cause one or more processor devices to:
receive a first set of computational information reflecting a utilization of computing resources of a first quantum service in a first quantum computing system that exceeds a computing resources threshold;
alter the computing resources of the first quantum service in the first quantum computing system based on the first set of computational information;
subsequent to alter the computing resources of the first quantum service in the first quantum computing system, determine that the utilization of computing resources of the first quantum service in the first quantum computing system continues to exceed the computing resources threshold; and
cause an initiation of a copy of the first quantum service onto a second quantum computing device in a second quantum computing system.
